(19) United States
(12) Patent Application Publication
(10) Pub. No.: US 2026/0119134 A1
(43) Pub. Date: Apr. 30, 2026

(54) TRACING AI GENERATED CODE

(71) Applicant: ATI Technologies ULC, Thornhill (CA)

(72) Inventors: Max KIEHN, Markham (CA); David Jonathan BRODSKI, Markham (CA); Alexander ANDRONCIK, Markham (CA); Andrej ZDRAVKOVIC, Markham (CA)

(21) Appl. No.: 18/930,687

(22) Filed: Oct. 29, 2024

(51) Int. Cl. G06F 8/35

(52) U.S. Cl. CPC G06F 8/35

(57) ABSTRACT

Embodiments herein relate to improving security measures when using AI for code generation. Embodiments herein include implementing technology that checks prompts before they are received by an AI model, as well as checking generated responses from an AI model. Checking prompts involves creating a database containing information regarding sensitive content, responses from the AI model, among other things. Additionally, the implemented technology is capable of generating appropriate prompts for an AI model when provided with a prompt containing sensitive information that would otherwise not be appropriate for the AI model.

### TECHNICAL FIELD

The embodiments presented relate to artificial intelligence (AI) and its role in computer code generation. AI can play a role in code generation by acting as an assistant for writing, debugging and optimizing code. For instance, AI tools integrated into coding environments can suggest entire code snippets, auto-complete lines, and provide contextual documentation as code is typed.

### BACKGROUND

When implementing AI in computer code generation, security concerns may arise. For example, when AI applications provide assistance in developing code, there is potential for introducing vulnerabilities into a code base. AI models are trained on vast amounts of data, which may include code with security flaws. If these flaws are inadvertently produced by AI generated code, it could lead to widespread security issues across multiple applications and systems. Additionally, AI may not fully understand the context or certain security measures of a project, potentially leading to code that does not adhere to best practices or regulatory compliance standards.

Additionally, with AI generated code, data leakage or intellectual property theft is a concern. Sensitive information is often inputted into AI systems, where the AI systems can retain such sensitive information and expose secrets. Additionally, there is a risk of malicious actors exploiting vulnerabilities in an AI system to gain access to sensitive data or manipulate the code generation process.

Furthermore, when using AI tools, there is a challenge of accountability and auditability. When AI systems generate code, it could be difficult to trace the decision making process that led to certain implementations. This lack of transparency can complicate debugging, security audits, and compliance efforts, among other things. The lack of transparence can also create challenges in determining liability if security breaches do occur due to AI generated code.

### SUMMARY

According to some embodiments, a method including: receiving, at an AI system, an input prompt instructing an AI model to generate code; detecting confidential content in the input prompt; upon determining the input prompt does not surpass a threshold value for an acceptable amount of confidential content, redacting the confidential content found in the input prompt, modifying the input prompt to ensure the input prompt is understandable to the AI system after redacting the confidential content; generating code using the AI system based on the modified input prompt; and logging the generated code from the AI model in an updateable code tracking database.

According to some embodiments, a system including: one or more processors; and one or more memories configured to store an application, which, when executed by a combination of the one or more processors, causes the combination of the one or more processors to perform an operation, the operation including: receiving, at an AI system, an input prompt instructing an AI model to generate code; detecting confidential content in the input prompt; upon determining the input prompt does not surpass a threshold value for an acceptable amount of confidential content, redacting the confidential content found in the input prompt, modifying the input prompt to ensure the input prompt is understandable to the AI system after redacting the confidential content; and generating code using the AI system based on the modified input prompt; and logging the generated code from the AI model in an updateable code tracking database.

According to some embodiments, a computer-readable storage medium having computer-readable program code embodied therewith, the computer-readable program code executable by one or more computer processors to: receive, at an AI system, an input prompt instructing an AI model to generate code; detect confidential content in the input prompt; upon determining the input prompt does not surpass a threshold value for an acceptable amount of confidential content, redacting the confidential content found in the input prompt, modify the input prompt to ensure the input prompt is understandable to the AI system after redacting the confidential content; and generating code using the AI system based on the modified input prompt; and logging the generated code from the AI model in an updateable code tracking database.

### BRIEF DESCRIPTION OF DRAWINGS

FIG. 1 illustrates a code tracking system, according to some embodiments.

FIG. 2 illustrates a prompt checker, according to some embodiments.

FIG. 3 illustrates a flow diagram of the code tracking system, according to some embodiments.

FIG. 4 illustrates a code tracking system, according to some embodiments.

FIG. 5 illustrates a flow diagram of the code tracking system, according to some embodiments.

FIG. 6 illustrates an auditing system, according to some embodiments.

### DETAILED DESCRIPTION

As mentioned above, using AI when generating code is efficient, but has shortcomings, especially concerning security. Embodiments herein relate to improving security measures when using AI for code generation. Embodiments herein check prompts before they are received by an AI model, as well as checking generated responses from an AI model. Checking prompts involves creating a database containing information regarding sensitive content, responses from the AI model, among other things. Additionally, the implemented technology is capable of generating appropriate prompts for an AI model when provided with a prompt containing sensitive information that would otherwise not be appropriate for the AI model.

Checking prompts for AI systems and tracking responses from AI systems using a database improves computational operations of the AI system, as the AI system itself will not have to be retrained. This saves memory and computing power of computing systems where the AI system is executed, thereby improving the functioning of technology.

Saving memory and computing power improves the system's performance, efficiency, and scalability. When less memory and computational resources are used, tasks execute faster, reducing latency and enabling more efficient multitasking. This enhances response times and lowers energy consumption. Efficient resource use also allows systems to handle larger workloads without costly hardware upgrades, improving scalability and reducing operational costs. Additionally, optimized memory and computing power leads to more reliable and stable systems. By preventing resource overloads, systems become less prone to crashes and slowdowns. Efficient memory management reduces issues such as memory leaks, resulting in smoother long-term performance.

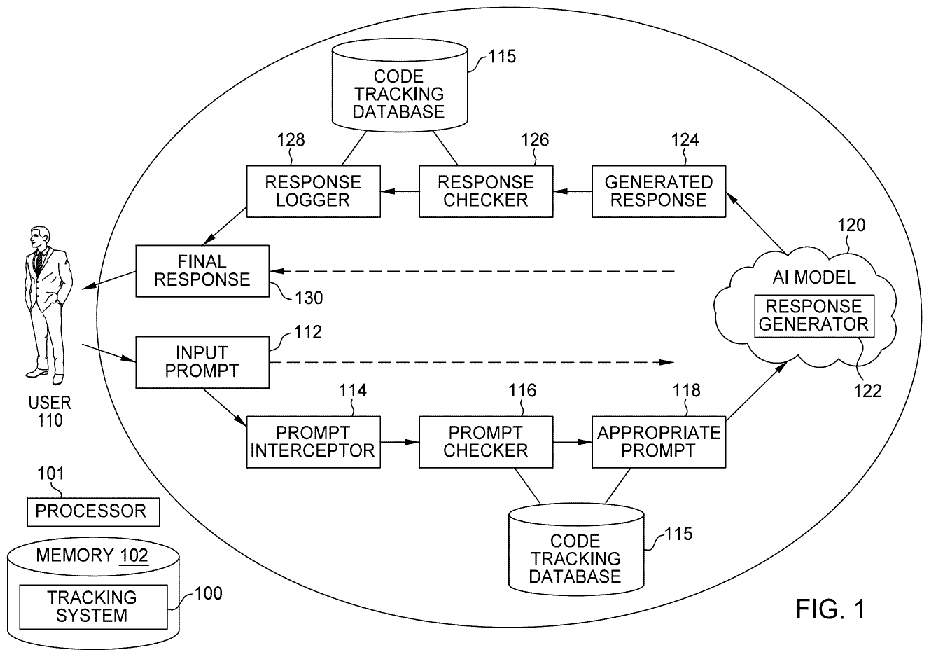

FIG. 1 illustrates a tracking system 100 that checks prompts from an AI system that generates code, checks responses from the AI system that generates code, and logs the prompts and responses into a database.

The tracking system 100 can be implemented on a computing system with a processor 101, and a memory 102. The processor 101 generally retrieves and executes programming instructions stored in the memory 102. The processor 101 is representative of a single central processing unit (CPU), multiple CPUs, a single CPU having multiple processing cores, graphics processing units (GPUs) having multiple execution paths, specialized AI hardware accelerators (e.g., systems of a chip), and the like.

The memory 102 generally includes program code for performing various functions related to use of the tracking system 100. The program code is generally described as various functional “applications” or “modules” within the memory 102, although alternate implementations may have different functions and/or combinations of functions. Within the memory 102, the tracking system 100 facilitates checking prompts for an AI system that generates code, checking responses from the AI system that generates code, and logging the prompts and responses into a database. This is discussed further, below.

A user 110 provides the tracking system 100 with an input prompt 112. The prompt interceptor 114 detects that an input prompt 112 has been provided and intercepts the input prompt 112. The prompt interceptor may intercept the input prompt 112 from a third party application or an internal application. The prompt interceptor 114 feeds the input prompt 112 to the prompt checker 116. The input prompt 112 undergoes a series of checks in the prompt checker 116, which will be discussed in further detail below. The prompt checker 116 uses a code tracking database 115 to facilitate the check, and also updates the code tracking database 115 with the original input prompt 112 that it checks. The prompt checker 116 uses the code tracking database 115 to produce an appropriate response 118 that is provided to the AI model 120. The AI model 120 receives the appropriate response 118 from the prompt checker 116, and uses its internal response generator 122 to provide a generated response 124 to the appropriate prompt 118 received. The generated response 124 undergoes a check of its own. To do so, the AI generated response 124 is received by a response checker 126. Similar to the prompt checker 116, the response checker 126 uses the code tracking database 115 to ensure the generated response 124 is appropriate. The response checker 126 provides the generated response to the response logger 128, which updates the code tracking database 115 with data indicating the AI generated and non AI generated portions of the code, and provides a final response 130 based on the response checker 126 to the user 110.

The input prompt 112 for the AI model 120 can take various forms, including natural language, code snippets, a combination of both, etc. The input prompt may be annotated/enriched automatically with additional data like open files, content of open files, file names, other files (, etc.) by the requester or third party system. When using natural language, the user 110 might describe what they would like the code to accomplish. For example, the prompt could say “write a function that sorts a list of integers.” This allows the AI model 120 to interpret the request and generate code based on the description. Alternatively, the prompt could include a mix of natural language and code where the user 110 provides an incomplete code snippet and asks the AI model to complete or debug it (e.g. “here's my function, but it is not working as expected. Can you fix it?”).

The input prompt 112 can be from a third party AI application or an internal AI application. Additionally, entire code snippets can be inputted into the prompt, along with comments explaining certain issues or desired functionality. The AI model 120 can analyze the code structure and make improvements, offer optimizations, or suggest alternatives. This flexibility makes input prompts 112 versatile, catering to users of various skill levels for various purposes. In some embodiments, the AI model 120 may be a software package that is constantly running on the device where code is being typed. It may receive, in real time, the input prompt 112 as it is entered into the computing system.

The prompt interceptor 114 recognizes the input prompt 112 as input for an AI model 120 and blocks the input prompt 112 from being immediately received by the AI model 120. The prompt interceptor 114 may recognize the prompt based on multiple recognition features. For example. The prompt interceptor 114 may recognize the structure and/or language of the text. Phrases that signal intent such as “how do I,” “can you,” or “generate code for,” etc. can indicate that the user 110 is requesting code generation or assistance. These natural language cues can appear as direct questions or commands that enable the prompt interceptor 114 to intercept the prompt 112.

Additionally, the prompt interceptor 114 can detect patterns that indicate a problem solving or instruction-seeking intent. For example, the command “write a function” is an imperative command related to coding. In some embodiments where the prompt is just code that is being monitored by the AI model as a user 110 writes, the prompt interceptor 114 may recognize and intercept the code (which is the input prompt 112) continuously.

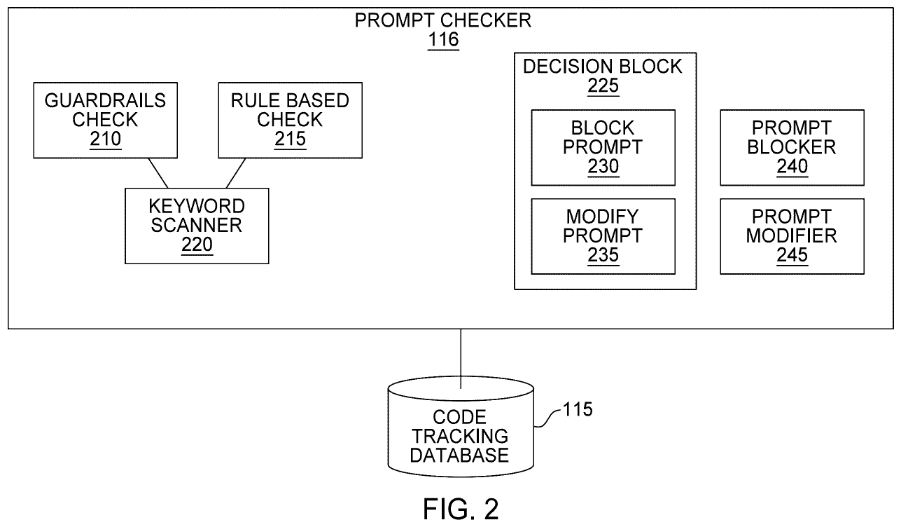

The prompt interceptor 114 intercepts and delivers the input prompt 112 to the prompt checker 116. The prompt checker 116 uses the updateable code tracking database 115 to determine whether the prompt is appropriate for the AI model to receive. The code tracking database 115 is discussed in more detail in FIG. 2. The appropriateness of the input prompt 112 may be determined by the readability of the prompt, and the amount of sensitive or confidential information that is present within the prompt. The code tracking database 115 helps the prompt checker 116 determine appropriateness of the input prompt 112. The prompt checker 116 may also update the updatable code tracking database with the original input prompt 112 intercepted by the prompt interceptor 114. In some embodiments, the prompt checker 116 blocks the input prompt 112 from being delivered, in other embodiments the prompt checker allows the original input prompt to reach the AI model 120, and in other embodiments the prompt checker redacts the sensitive or inappropriate information contained in the input prompt 112. More details are provided in FIG. 2.

The AI model 120 receives the appropriate prompt 118 from the prompt checker 116. The AI model 120 may be one of many types of AI models, as there are several types of AI models capable of assisting with code generation. Such models include language models (LMs). LMs are AI models trained on vast amounts of natural language data, including programming code. These models can understand natural language prompts, generate code snippets, provide explanations, debug existing code based on user input, among other things. LMs can work across multiple programming languages, are versatile, and support a wide range of tasks from code synthesis to error resolution.

Another type of AI model can be a specialized code model. Specialized code models are trained for certain programming tasks, with a large focus on understanding and generating code. Specialized code models may be fine-tuned for code generation and trained on large code repositories. Specialized models may generate complex code structures, help with auto completion, translate between code languages, and improve development workflows.

Another of example of an AI model is a transformer for code which are models based on transformer architecture, designed to understand and generate code, as well as perform tasks such as code search classification and repair. Unlike general purpose models, transformers are trained on paired natural language descriptions and code snippets, enabling them to generate code that directly maps to a given description or comment, improving the relevance of their suggestions.

The AI model 120 is not limited to the examples presented herein.

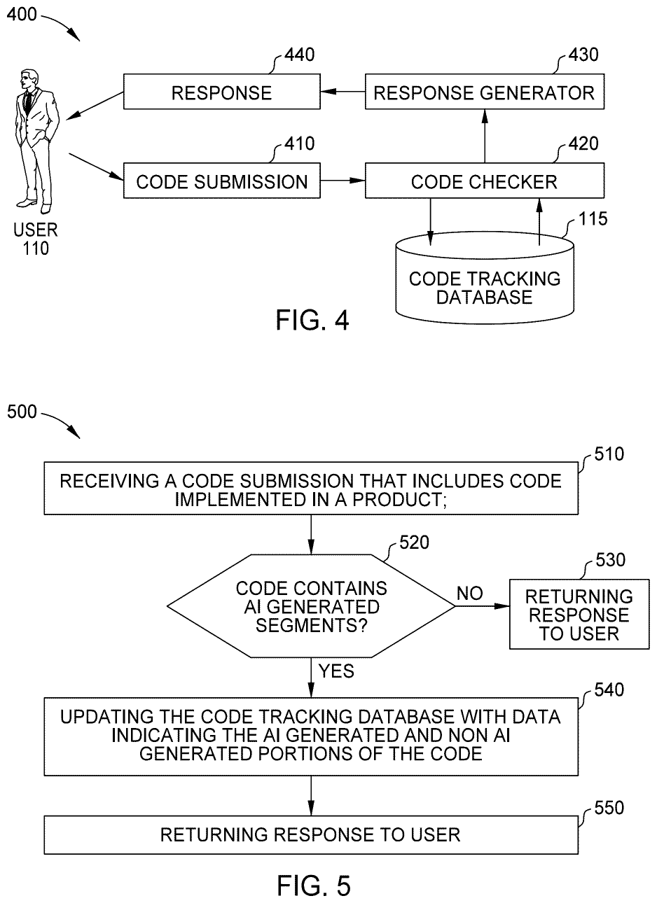

The AI model 120 uses its response generator 122 feature to output a generated response 124. The generated response 124 can also be checked by a response checker 126. Similar to the prompt checker, the response checker 126 uses the code tracking database 115 to ensure that the generated response 124 from the AI model 120 does not contain confidential or sensitive information. The code tracking database 115 can be updated with the generated response 122, which can be used in different embodiments, as described in FIG. 4 and FIG. 5. The final response 130, which may be the same generated response 124 or an edited version of the general response 130 by the response logger 128 is presented to the user 110.

FIG. 2 illustrates the details of the prompt checker 116 according to one embodiment. As mentioned in FIG. 1, the prompt checker 116 receives an input prompt 112 from the prompt interceptor 114. The prompt checker 116 performs a check on the input prompt 112. The prompt checker 116 contains a guardrails check 210 component, and a rule based check 215 component which implement a keyword scanner 220. Additionally, the prompt checker 116 contains a decision block 225, within which is a block prompt 230 module and a modify prompt 235 module. There is also a prompt blocker 240 and prompt modifier 245 within the prompt checker 116.

The guardrails check 210 and rule based check 215 are two different check mechanisms the input prompt 112 undergoes to determine whether or not the input prompt 112 is appropriate for sending to the AI model 120. The guardrails check 210 accesses up to date internal guidance from the code tracking database 115 to determine whether or not the input prompt 112 is aligned with internal policies set forth. The actual AI model implemented within the guardrails check 210 does not need to be fine-tuned, in some embodiments. Rather, the updated code tracking database 115 containing internal guidelines the input prompt 112 should meet is accessed, and the input prompt 112 is evaluated using those guidelines. Examples of internal guidelines include but are not limited to certain words or phrases that are considered trade secrets, inappropriate language, etc.

Similarly, the rule based check 215 that the input prompt 112 also undergoes uses a customizable ruleset. The customizable ruleset can also be found in the code tracking database 115. The ruleset can be used to detect anomalies in the requests and AI generated responses to prevent intentional or accidental abuse of AI tools. For example, it may prevent a malicious user generating a large amount of code, or an AI tool malfunctioning and spamming requests.

Both the rules based check 215 and the guardrails check 210 can be implemented using a keyword scanner 220. The keyword scanner 220 may be implemented as a tool or algorithm designed to analyze the intercepted input prompt 112 by searching for certain keywords or patterns that match the guardrails or rules stored in the code tracking database 115. The keyword scanner 220 enables the guardrails check 210 and the rule based check 215 to recognize certain commands, terms or structures within the user input prompt 112 and associate those commands, terms or structures with existing rules in the updateable code tracking database 115. For example, the keyword scanner 220 may dissect the input prompt 112 to terms (e.g. programming languages, functions, or common operations). The keywords that are identified can then be compared against the rules or templates stored in the code tracking database 115, which define whether or not the input prompt 112 is appropriate to send to the AI model 120. For example, if the prompt contains the phrase “trade secret,” the keyword scanner can flag the prompt, and match it to a rule stating that the phrase “trade secret” cannot be included in a prompt for the AI model 120. The updateable code tracking database 115 improves the tracking system's 100 flexibility, as the rules of the code tracking database 115 can be continuously revised to include new coding trends, languages, or methods, without altering the core function of the keyword scanner 220.

Once the input 112 is checked for inappropriate or confidential content, the decision block 225 assesses the level of acceptability of the input prompt 112. This means that based on the keyword scanner's 220 determination of the appropriateness of the input prompt 112, the decision block 225 decides whether the prompt 112 should be modified and sent to the AI model 120, whether the prompt 112 should be blocked completely from being sent to the AI model 120, or whether the prompt 112 can be sent to the AI model 120 as is.

In some embodiments, the decision block 225 is programmed to recognize a threshold value for an acceptable amount of confidential content, or inappropriate content that the input prompt 112 can contain when the input prompt 112 reaches the prompt checker. In some embodiments, the threshold is a predefined limit, whereas in others, the threshold may be learned/adaptable. Checking for a threshold value for an acceptable amount of confidential content refers to the decision block 225 evaluating whether the predefined, or learned/adaptable limit for inappropriate content has been crossed. For example, if it is determined that the threshold for inappropriate content is 60 percent of the prompt or less, if the decision block 225 evaluates the results from the keyword scanner 220 and determines that the prompt contains only 55 percent of inappropriate content, the decision block may initiate its modify prompt 235 module. If the decision block 225 evaluates the results from the keyword scanner 220 and determines that 65 percent of the prompt contains inappropriate content, which surpasses the threshold of 60 percent, the decision block may initiate its block prompt 230 module. Alternatively, if there is no detected confidential/inappropriate content from the keyword scanner 220, the decision block 225 allows the prompt through, without having to initiate the block prompt 230 module or the modify prompt 235 module.

When the decision block 225 initiates the block prompt 230 module, the prompt blocker 240 prevents the input prompt 112 from moving through to the AI model 120. In some embodiments, the prompt blocker 240 sends a message to the user 110 indicating that the prompt has been blocked.

When the decision block 225 initiates the modify prompt 235 module, the prompt modifier 245 changes the prompt so that the detected confidential/inappropriate information is redacted from the prompt. The prompt 112 can be reworded so that it conveys the same message as the original input prompt 112, but without the sensitive information that was redacted. The reworded prompt may maintain readability and grammatical structure. For example, if client names and account numbers are considered confidential content, and the original prompt states “write code that will output a list of all client accounts starting with John Doe, account number 1234567” the reworded prompt may be “write code that will output a list of all client accounts, starting with the first account in the registry.” The reworded prompt prevents the sensitive information from reaching the AI model, but ensures the meaning of the original prompt reaches the AI model. This allows the AI model to provide a useful response without processing confidential or sensitive company information.

The outcome from the decision block 225 is recorded in the code tracking database 115. If the prompt 112 is reworded by the prompt modifier 245, the reworded prompt is also recorded in the code tracking database 115.

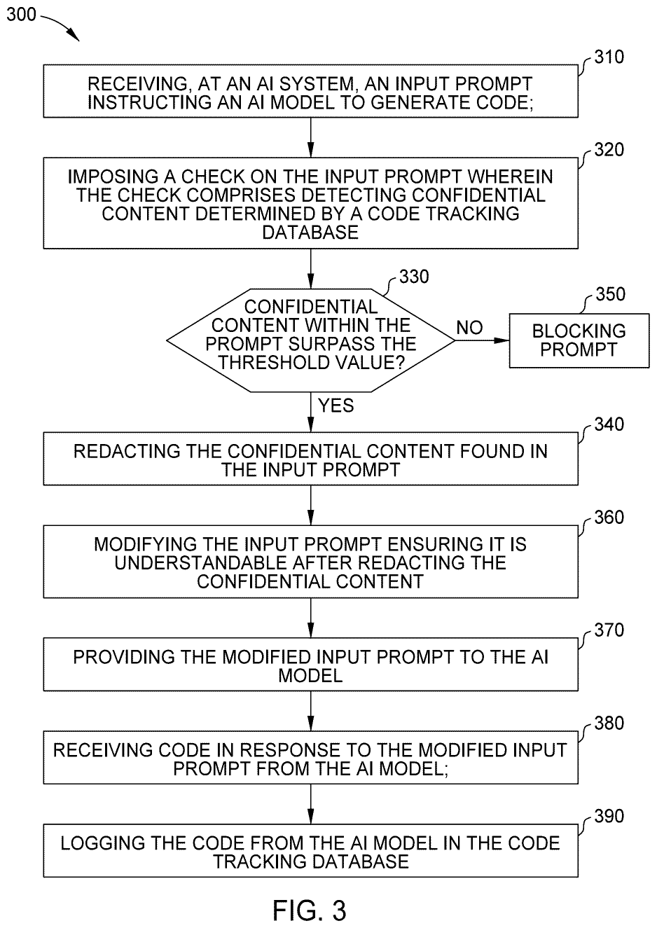

FIG. 3 illustrates the flowchart 300 of the tracking system 100.

At block 310 the tracking system 100 receives an input prompt instructing an AI model to generate code or assist with code generation. As mentioned in FIG. 1, the input prompt can come in various formats, with various instructions for the AI model.

At block 320 the prompt interceptor 114 intercepts the input prompt and sends the intercepted prompt to the prompt checker. The prompt checker checks the input prompt for confidential content. As discussed in FIG. 2, the prompt checker uses a keyword search of the code tracking database to determine whether or not the input prompt's content is confidential/appropriate. The data's content's appropriateness is evaluated based on a guardrails check (of which updated information is found in the code tracking database) and a rule based check (also of which, updated rules are found in the code tracking database). This process was described in more detail in FIG. 2.

At block 330, the decision block evaluates the results of the keyword search and determines whether the amount of sensitive content detected in the input prompt exceeds a certain threshold. As discussed in FIG. 2, the threshold value may be a predetermined value, or a learned, adaptable value.

At block 350 the decision block determines that the threshold value for inappropriate content has been exceeded, and therefore the prompt is blocked from reaching the AI model.

At block 340 the decision block determines that that amount of inappropriate content within the input prompt has not been exceeded. Having made that determination, the modify prompt module of the decision block is activated and the confidential or inappropriate content from the input prompt is redacted as described in FIG. 2.

At block 360 the prompt modifier of the prompt checker modifies the input prompt, ensuring it is understandable after the confidential content has been redacted from the original prompt. After redacting information from the prompt, the prompt can be reworded to ensure that the core meaning remains intact and understandable without revealing confidential data. This process can involve rephrasing the prompt to preserve key concepts, context and structure so that the recipient (e.g., the AI model) can still grasp the core message. For example, sensitive or confidential information such as names, numbers or proprietary terms might be replaced with generic placeholders or descriptions, allowing the prompt to be communicated effectively without compromising sensitive information.

At block 370 the modified input prompt is provided to the AI model. As described in FIG. 1, the AI model may be one of or a combination of a variety of different types of models.

At block 380 the tracking system is provided with a response, which may be code or a suggestion for enhancing code, among other things, from the AI model. The response from the AI model can include a code snippet that directly addresses the task or problem described in the modified prompt. For example, if the modified prompt asks the AI model to “generate a python function that sorts lists” the AI will respond with a Python function that uses a suitable sorting algorithm. Along with code, the AI model may provide an explanation or comments within the code to describe what each part does, helping the user understand how the solution works and how to implement it into their project.

Additionally, the generated response from the AI model may include a step-by-step breakdown or suggestions on how to improve or extend the code. If the modified response indicates the desire for debugging assistance, the AI model may identify potential errors in the existing code, explain what might be going wrong, and offer fixes. For example, if the modified prompt says “my loop is not working as expected, can you help?” the AI model may analyze the logic of the loop, point out the issues, and suggest a correction.

At block 390 the response from the AI model is logged into the code tracking database. Logging the generated response into the code tracking database may involve inserting or storing certain data into a predefined structure inside of the code tracking database. This process may start with the request logger sending a request (such as an SQL query) to the database, indicating the data should be recorded. The database may process the request and validate the data to ensure the data fits the format and constraints of the database. The database may then add the data (in this case, the AI generated response) to the appropriate table. Once the data is successfully inserted, the database logs the action, making it retrievable for future queries or analysis.

FIG. 4 illustrates an embodiment 400 where a user wishes to determine whether or not a code snippet contains AI generated portions of code. In this embodiment, the user 110 presents a code submission 410 to the tracking system 100. The purpose of this code submission 410 is to determine whether it contains AI generated portions of code. A code checker 420 receives the submission. The code checker 420 uses the code tracking database 115, which contains logged AI generated responses 124, and compares the code submission 410 to the logged AI generated responses 124 of the code tracking database 115.

Using the code tracking database 115, which contains previously logged AI generated responses 124 to compare against the new code submission 410, can involve applying algorithms or pattern matching techniques to analyze the new code submission 410. When the code submission 410 is received by the code checker 420, the code checker 420 can compare the code submission 410 to the AI generated code responses 124 in the code tracking database 115. The code checker 420 can check for similarities in structure, syntax or exact matches. By identifying such overlaps, the code checker 420 can determine whether segments of the code submission 410 have been generated by AI.

The comparison can take various forms from being simple string matching to more advanced methods such as hashing or fuzzy matching techniques, which look for approximate similarities in code patterns even if minor modifications have been made. For instance, if two pieces of code differ only slightly, fuzzy matching algorithms can still detect similarities. Additionally, if the code checker 420 is trained on a large corpora of AI generated content, the code checker 420 can recognize certain coding styles or patterns often produced by AI, further helping flag potential AI code generation.

Additionally, the code checker 420 can examine metadata or certain stylistic markers of the code submission 410. AI models may follow predictable patterns in their code generation, such as consistent indentation, certain naming conventions, or formatting styles. Such markers, combined with the data from the code tracking database 115 also can help the code checker 420 determine that the code was AI generated.

After determining whether or not the code submission 410 contains AI generated code, the response generator 430 analyzes the results from the code checker 420 and produces a response 440 that is sent to the user 110. The response 440 may highlight which portion of the code submission 410, is AI generated, a generic “yes” or “no” answer as to whether the code submission 410 contains AI generated code, among other things.

FIG. 5 illustrates a flowchart 500 of the embodiment 400, where a user checks to see if a code snippet contains AI generated code.

At block 510 the code checker receives a code submission. The code submission may include code from a product implemented by an organization. The code submission may be a small focused segment of code for review, analysis or execution. The snippet may represent a certain functionality or task such as a function, loop or algorithm, though the submission may vary in size and significance.

At block 520 the code checker performs a check on the code submission to determine whether or not the code submission contains AI generated segments. Potential methods used to perform this check were described in FIG. 4.

At block 530 a response is returned to the user indicating that the code does not contain AI generated code.

At block 540 the code checker determines that the code submission does contain AI generated code. Upon making this determination, the code checker updates the code tracking database with code submission, and labels it as containing AI generated code within the database. This update provides more data for the code checker to work with in the future. Updating the code tracking database is discussed in FIG. 3.

At block 550 the response generator generates a response indicating that there is AI generated code in the code submission. The response generator and the response it generates is discussed in FIG. 4.

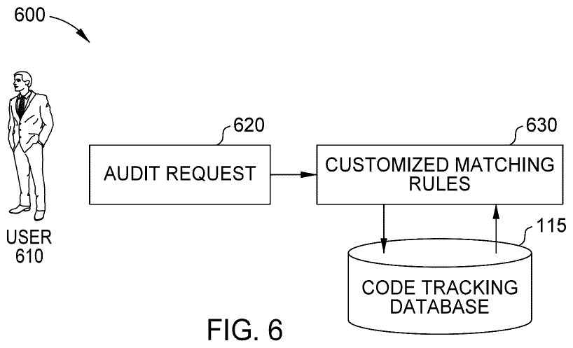

FIG. 6 illustrates an embodiment 600 where an auditor 610 ensures that the AI generated code submitted to the code tracking database 115 meets legal and regulatory standards.

The auditor 610, which may be a done manually by a human or electronic entity, submits an audit request 620 for the code tracking database 115. The audit request 620 may be for certain submissions of AI generated code received by the code tracking database 115, or for all of the AI generated code received by the code tracking database. Upon receiving the audit request, the code tracking database 115 compares its stored AI generated code to a customized matching rules 630 set. The customized matching rules 630 may be rules that indicate confidential or inappropriate information in the format of computer code. If AI generated code exhibits traits from the customized matching rules 630 set, legal action or further investigation as to how an AI model was able to access such confidential information and generate code may be initiated. Search methods regarding ways the customized matching rules 630 are measured against the existing AI generated code in the code tracking database were discussed in FIG. 2.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product.

Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method comprising:
receiving, at an AI system, an input prompt instructing an AI model to generate code;
detecting confidential content in the input prompt;
upon determining the input prompt does not surpass a threshold value for an acceptable amount of confidential content, redacting the confidential content found in the input prompt,
modifying the input prompt to ensure the input prompt is understandable to the AI system after redacting the confidential content;
generating code using the AI system based on the modified input prompt; and
logging the generated code from the AI model in an updateable code tracking database.

2. The method of claim 1 further comprising:
receiving, at the AI system, a code submission;
checking whether or not the code submission contains AI generated portions; and
updating the code tracking database with data indicating the AI generated and non AI generated portions of the code submission.

3. The method of claim 1 further comprising:
receiving, at the AI system, a code submission;
manually auditing the code submission by comparing the code submission to existing code in the updatable code tracking database; and
determining whether or not portions of the code submission are AI generated based on the comparison.

4. The method of claim 1, wherein the input prompt is received from a third party AI application or an internal AI application.

5. The method of claim 4, wherein the input prompt received from the third party application is intercepted after being received by the AI system, and a check is imposed on the intercepted input prompt.

6. The method of claim 5, wherein the input prompt received from the internal AI application is tracked and recorded such that a check is imposed in parallel with the tracking and recording of the prompt.

7. The method of claim 4 wherein checking the input prompt comprises a rule based check and a guardrails check, wherein the rule based check and the guardrails check comprises comparing the input prompt to a set of rules defined in the code tracking database.

8. A system comprising:
one or more processors; and
one or more memories configured to store an application, which, when executed by a combination of the one or more processors, causes the combination of the one or more processors to perform an operation, the operation comprising:
receiving, at an AI system, an input prompt instructing an AI model to generate code;
detecting confidential content in the input prompt;
upon determining the input prompt does not surpass a threshold value for an acceptable amount of confidential content, redacting the confidential content found in the input prompt,
modifying the input prompt to ensure the input prompt is understandable to the AI system after redacting the confidential content; and
generating code using the AI system based on the modified input prompt; and
logging the generated code from the AI model in an updateable code tracking database.

9. The system of claim 8 further comprising:
receiving, at the AI system, a code submission;
checking whether or not the code submission contains AI generated portions; and
updating the code tracking database with data indicating the AI generated and non AI generated portions of the code submission.

10. The system of claim 8 further comprising:
receiving, at the AI system, a code submission;
manually auditing the code submission by comparing the code submission to existing code in the updatable code tracking database; and
determining whether or not portions of the code submission are AI generated based on the comparison.

11. The system of claim 8, wherein the input prompt is received from a third party AI application or an internal AI application.

12. The system of claim 11, wherein the input prompt received from the third party application is intercepted after being received by the AI system, and a check is imposed on the intercepted input prompt.

13. The system of claim 12, wherein the input prompt received from the internal AI application is tracked and recorded such that a check is imposed in parallel with the tracking and recording of the prompt.

14. The system of claim 11 wherein checking the input prompt comprises a rule based check and a guardrails check, wherein the rule based check and the guardrails check comprises comparing the input prompt to a set of rules defined in the code tracking database.

15. A computer-readable storage medium having computer-readable program code embodied therewith, the computer-readable program code executable by one or more computer processors to:
receive, at an AI system, an input prompt instructing an AI model to generate code;
detect confidential content in the input prompt;
upon determining the input prompt does not surpass a threshold value for an acceptable amount of confidential content, redacting the confidential content found in the input prompt,
modify the input prompt to ensure the input prompt is understandable to the AI system after redacting the confidential content; and
generating code using the AI system based on the modified input prompt; and
logging the generated code from the AI model in an updateable code tracking database.

16. The computer readable program code of claim 15 further comprising:
receiving, at the AI system, a code submission;
checking whether or not the code submission contains AI generated portions; and
updating the code tracking database with data indicating the AI generated and non AI generated portions of the code submission.

17. The computer readable code of claim 15 further comprising:
receiving, at the AI system, a code submission;
manually auditing the code submission by comparing the code submission to existing code in the updatable code tracking database; and
determining whether or not portions of the code submission are AI generated based on the comparison.

18. The computer readable code of claim 15, wherein the input prompt is received from a third party AI application or an internal AI application.

19. The computer readable code of claim 18, wherein the input prompt received from the third party application is intercepted after being received by the AI system, and a check is imposed on the intercepted input prompt.

20. The computer readable code of claim 19, wherein the input prompt received from the internal AI application is tracked and recorded such that a check is imposed in parallel with the tracking and recording of the prompt.
